(19) United States
(12) Patent Application Publication
(10) Pub. No.: US 2021/0076228 A1
(43) Pub. Date: Mar. 11, 2021

(54) METHODS AND APPARATUS TO FACILITATE IMPROVING MILLIMETER WAVE COMMUNICATIONS VIA DEVICE ORIENTATION ALIGNMENT

(71) Applicant: QUALCOMM Incorporated, San Diego, CA (US)

(72) Inventor: Junsheng HAN, Sunnyvale, CA (US)

(21) Appl. No.: 16/562,200

(22) Filed: Sep. 5, 2019

(51) Int. Cl. H04W 24/02; H04B 7/08; H04B 7/0408; H01Q 3/02; H04W 16/24

(52) U.S. Cl. CPC H04W 24/02; H04B 7/0882; H04W 24/08; H01Q 3/02; H04W 16/24; H04B 7/0408

(57) ABSTRACT

Apparatus, methods, and computer-readable media for facilitating improving millimeter wave communications via device orientation alignment are disclosed herein. An example method for wireless communication at a user equipment (UE) includes estimating a direction of a base station serving beam in relation to a spherical coverage mapping of the UE. The example method also includes identifying one or more rotation vectors for adjusting an orientation of the UE based on the direction of the base station serving beam and the spherical coverage mapping. Also, the example method includes applying at least one rotation vector to adjust the orientation of the UE.

### BACKGROUND

### Technical Field

The present disclosure relates generally to communication systems, and more particularly, to wireless communications including millimeter wave communications.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G/NR is part of a continuous mobile broadband evolution promulgated by Third Generation Partnership Project (3GPP) to meet new requirements associated with latency, reliability, security, scalability (e.g., with Internet of Things (IoT)), and other requirements. 5G/NR includes services associated with enhanced mobile broadband (eMBB), massive machine type communications (mMTC), and ultra reliable low latency communications (URLLC). Some aspects of 5G/NR may be based on the 4G Long Term Evolution (LTE) standard. There exists a need for further improvements in 5G/NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. An example apparatus for wireless communication at a UE estimates a direction of a base station serving beam in relation to a spherical coverage mapping of the UE. The example apparatus also identifies one or more rotation vectors for adjusting an orientation of the UE based on the direction of the base station serving beam and the spherical coverage mapping. Also, the example apparatus applies at least one rotation vector to adjust the orientation of the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a first 5G/NR frame, DL channels within a 5G/NR subframe, a second 5G/NR frame, and UL channels within a 5G/NR subframe, respectively.

FIG. 3 is a diagram illustrating an example of a base station and user equipment (UE) in an access network.

FIG. 4 is a diagram illustrating a base station in communication with a UE.

FIG. 5 depicts an example spherical coverage distribution, in accordance with the teachings disclosed herein.

FIG. 6 depicts an example interface of a UE, in accordance with the teachings disclosed herein.

FIG. 7 illustrates example UEs mounted to motorized holding apparatuses, in accordance with the teachings disclosed herein.

FIG. 8 is an example communication flow between a base station and a UE, in accordance with the teachings disclosed herein.

FIG. 9 is a flowchart of a method of wireless communication at a UE, in accordance with the teachings disclosed herein.

FIG. 10 is a conceptual data flow diagram illustrating the data flow between different means/components in an example apparatus.

FIG. 11 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, the term computer-readable medium is expressly defined to include any type of computer readable storage device and/or storage disk and to exclude propagating signals and to exclude transmission media. As used herein, “computer-readable medium,” “machine-readable medium,” “computer-readable memory,” and “machine-readable memory” are used interchangeably.

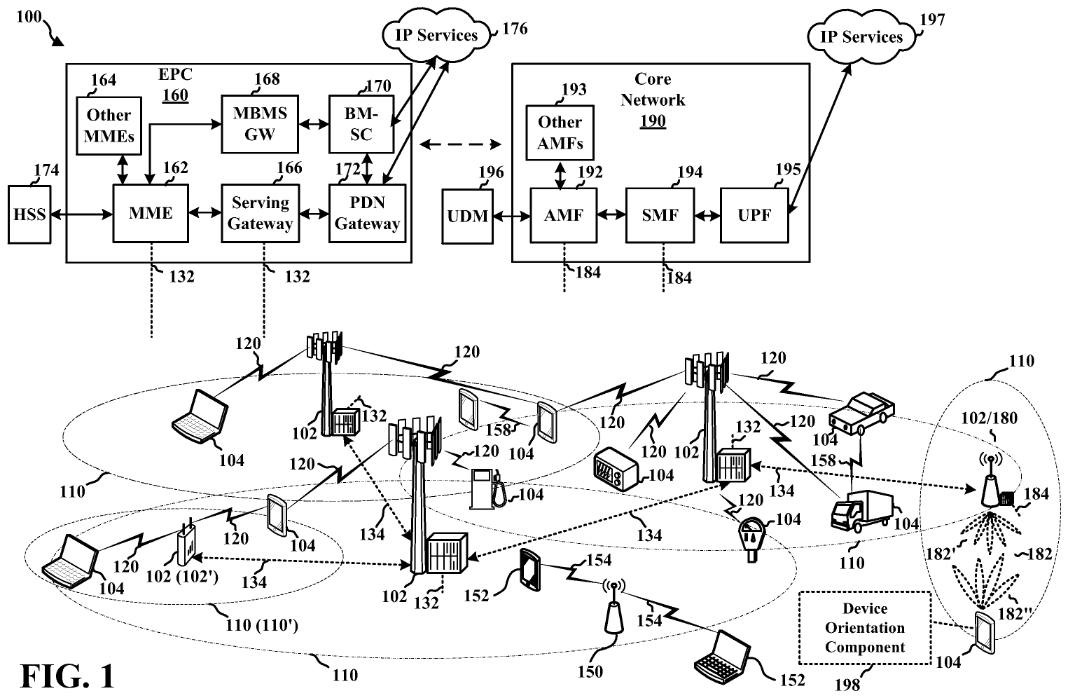

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G/NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to manage one or more aspects of wireless communication via improving mmW communications via device orientation alignment. As an example, in FIG. 1, the UE 104 may include a device orientation component 198 configured to estimate a direction of a base station serving beam in relation to a spherical coverage mapping of the UE. The example device orientation component 198 may also be configured to identify one or more rotation vectors for adjusting an orientation of the UE based on the direction of the base station serving beam and the spherical coverage mapping. The example device orientation component 198 may also be configured to apply at least one rotation vector to adjust the orientation of the UE.

Although the following description may be focused on 5G/NR and, in particular, mmW communications, the concepts described herein may be applicable to other similar areas, such as LTE, LTE-A, CDMA, GSM, and/or other wireless technologies, in which device orientation alignment may be used to facilitate improving wireless communications.

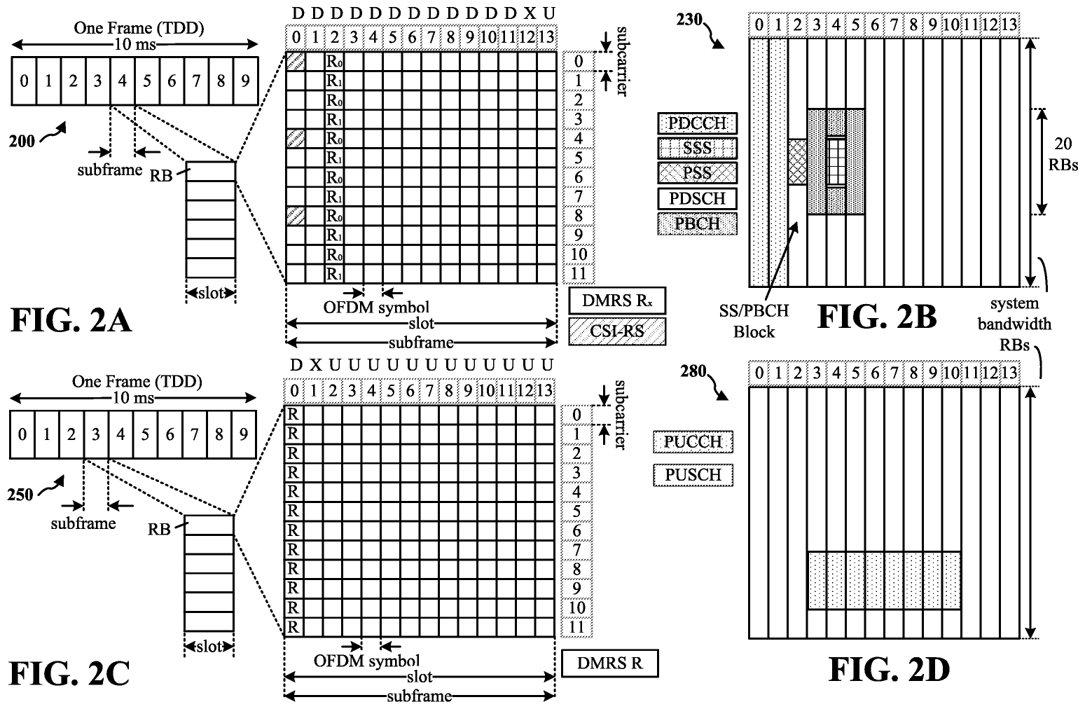

FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μ slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A to 2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

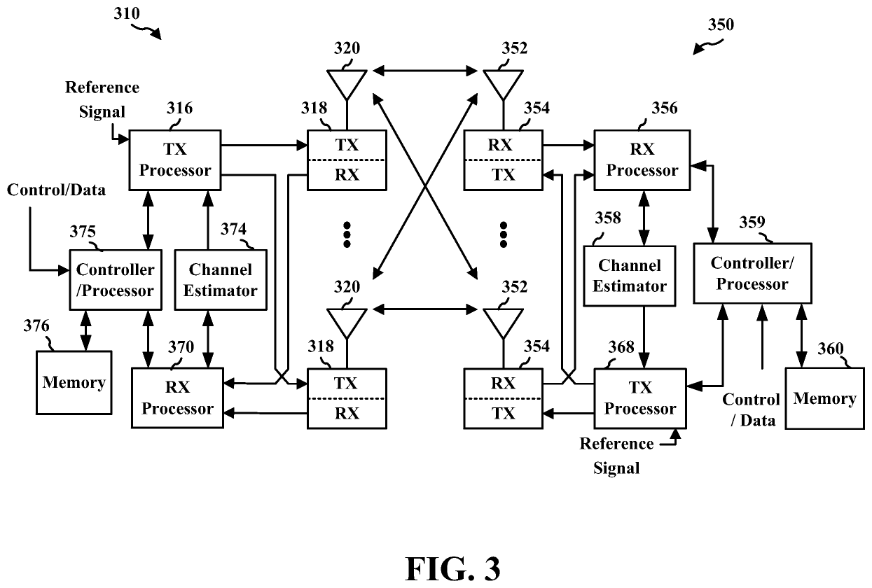

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 of the UE 350 may be configured to perform aspects in connection with device orientation component 198 of FIG. 1.

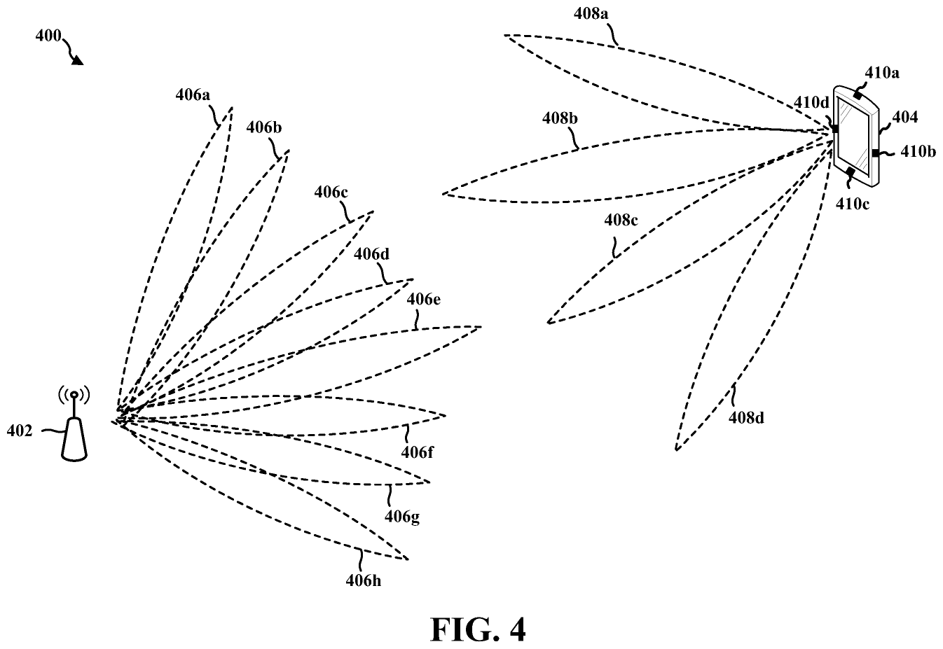

FIG. 4 is a diagram 400 illustrating a base station 402 in communication with a UE 404. Referring to FIG. 4, the base station 402 may transmit a beamformed signal to the UE 404 in one or more of the directions 406a, 406b, 406c, 406d, 406e, 406f, 406g, 406h. The UE 404 may receive the beamformed signal from the base station 402 in one or more receive directions 408a, 408b, 408c, 408d. The UE 404 may also transmit a beamformed signal to the base station 402 in one or more of the directions 408. The base station 402 may receive the beamformed signal from the UE 404 in one or more of the receive directions 406. The base station 402/UE 404 may perform beam training to determine the best receive and transmit directions for each of the base station 402/UE 404. The transmit and receive directions for the base station 402 may or may not be the same. The transmit and receive directions for the UE 404 may or may not be the same.

Millimeter wave (mmW) wireless communication systems (e.g., devices that operate at 28 GHz, 39 GHz, etc.) include the potential of providing relatively higher data rates compared to other communication systems, such as those operating in the sub-6 GHz frequency range. An example of such a mmW wireless communication systems includes 5G/NR, which may operate in the mmW frequency range (FR2). However, communicating at mmW frequencies may result in relatively higher attenuation when compared to communication systems operating in the sub-6 GHz frequency range. For example, due to the relatively small wavelengths associated with the mmW frequency range, mmW propagation may be susceptible to blocking (e.g., via a building, a wall, a hand, etc.).

Beamforming is an example technique for countering the relatively high attenuation possibilities. For example, beamforming may provide array gain by co-phase combining across multiple antenna elements of a device for a devein angle of arrival and/or departure. As disclosed above in connection with FIG. 4, beamforming may be performed with transmit antennas (sometimes referred to as “antenna modules” or “antenna elements”) and/or receive antennas.

However, due to the physical characteristics of transmit antennas and receive antennas (generally referred to herein as “antennas”), beams may not be able to cover all spatial directions equally well. For example, the coverage of a device (e.g., UE 404) may be limited by the number of antennas 410a, 410b, 410c, 410d (or antenna arrays), the placement of the antennas, the types of antennas, etc.

Spherical coverage (for downlink communications and for uplink communications) represents a degree to which a UE can cover different angles in space with different beams. For example, a spherical coverage may correspond to how much power a UE can provide in different directions. In some examples, a spherical coverage may be pre-characterized as a three-dimensional model based on a UE beamforming codebook. In some examples, the spherical coverage may correspond to a distribution of radiated power. For example, radiated power may be measured in effective isotropic radiated power (EIRP) or effective isotropic sensitivity (EIS). In some examples, it may be beneficial to provide minimum performance guidelines for operating at particular radiated power levels.

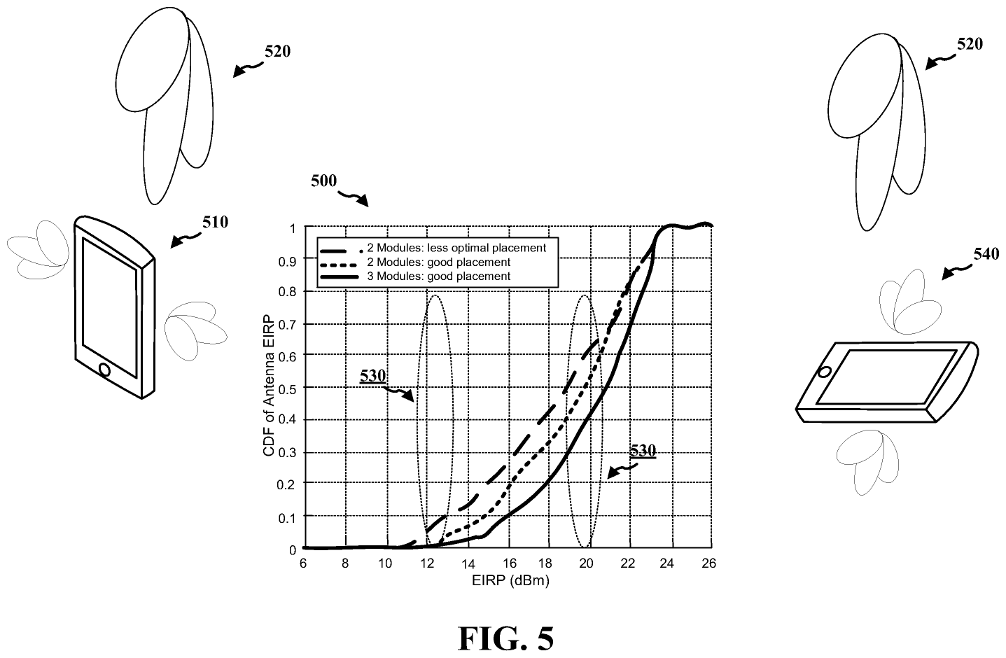

FIG. 5 illustrates an example spherical coverage 500. The example spherical coverage 500 depicts an example distribution of antenna radiated power percentiles at different radiated power measurements. In the example of FIG. 5, the radiated power is measured in EIRP. However, it should be appreciated that in other examples, other techniques for measuring the radiated power may additionally or alternatively be used, such as EIS.

As disclosed above, the physical characteristics of an antenna may limit the coverage available to a UE. In some examples, a UE may include multiple antennas to increase the overall coverage provided to the UE. However, as the number of antennas in a device increases, the bill of materials associated with the device increases, and so may the cost of the device.

Examples disclosed herein provide techniques for adjusting the orientation of a UE so that a serving base station beam may be aligned with stronger directions with respect to a spherical coverage mapping associated with the UE. For example, techniques disclosed herein may dynamically adjust the orientation of the UE so that the UE is pointing to a relatively stronger section of the spherical distribution in relation to the serving base station beam. For example, the serving base station beam may be arriving at the UE at an inopportune angle relative to the UE. In some such examples, an orientation adjustment may increase the gain and improve performance of the UE. In some examples, adjusting the orientation of the UE may correspond to shifting from one portion of the spherical coverage distribution to another portion of the spherical coverage distribution.

For example, referring back to FIG. 5, at a first time, a UE may be in a first orientation 510 in relation to a serving base station beam 520. While in the first orientation 510, the link quality may be associated with a first portion 530 of the spherical coverage 500. The orientation of the UE may then be adjusted so that the UE is in a second orientation 540 in relation to the serving base station beam 520. While in the second orientation 540, the link quality may be associated with a second portion 550 of the spherical coverage 500.

Techniques disclosed herein enable a UE to estimate a direction of a base station serving beam in relation to the special coverage mapping of the UE. The example techniques also disclose identifying and selecting a rotation vector that may be applied to the UE so that the stronger direction of the UE is aligned with the base station serving beam. The disclosed techniques may then facilitate applying the rotation vector to the UE to improve the link quality between the UE and the serving base station. In some examples, the UE may then identify and update its measured beam pair link. It should be appreciated that in some examples, the disclosed techniques may repeated continuously, periodically, or when triggered to maintain and/or improve the alignment of the UE with respect to the base station serving beam and the spherical coverage mapping of the UE.

In some examples, the selecting and/or the applying of the rotation vector may be performed manually. For example, the UE may provide (or be in communication with) an interface, such as a display device. The UE may then receive sensor feedback from the UE and guide a user via the interface to rotate the UE. In some examples, the selecting and/or applying of the rotation vector may be performed automatically (e.g., without user input). For example, the UE may be mounted to a holding apparatus that includes a motor. In some such examples, the UE may communicate with the holding apparatus to adjust the orientation of the UE.

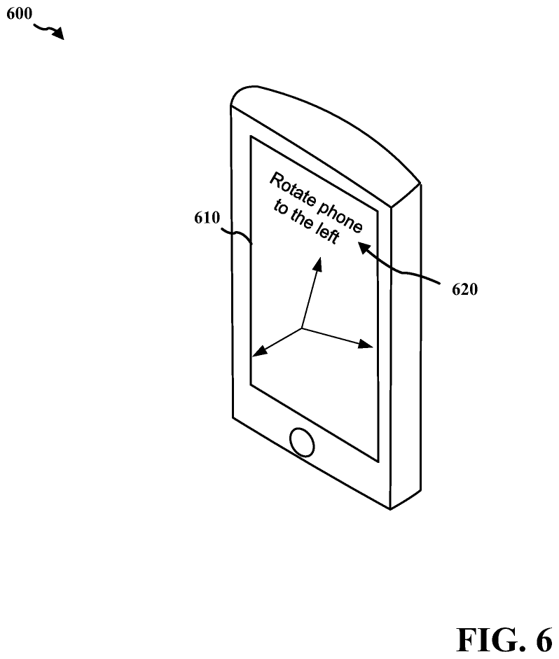

As an illustrative example, consider a UE in communication with a serving base station. The UE may detect that the link quality of the communication is within an area of low coverage (or “valley”) of the spherical coverage mapping of the UE. In some examples, the UE may also determine that the UE is stationary (e.g., via an accelerator and/or other sensors) and that the communication with the service base station is an active mmW communication. In some such examples, the UE may provide a notice to a user (e.g., via a user interface of a display device of the UE) that better communication performance may be archived by adjusting the orientation of the UE. The UE may also provide a visual aid to the user (e.g., via the user interface) that directs the user on how to adjust the orientation of the UE. For example, FIG. 6 depicts an example UE 600 including a display device 610. In the illustrated example, the UE 600 is displaying, via the display device 610, a visual aid 620 instructing the user to “Rotate the phone to the left” to improve the link quality of the communication. In some examples, as the user rotates the UE, the user may be able to see (e.g., via the user interface) how the adjusting of the orientation of the UE is changing the link quality of the communication. The user may then select an updated orientation of the UE (and the notification of the better communication performance may be cleared).

In some examples, the above example may be repeated when one or more conditions are met (or triggered). For example, the UE may provide the notice to the user after a determination that the link quality of the communication is within an area of low coverage of the spherical coverage mapping of the UE for a threshold period. In some examples, the UE may prompt the user when the UE is stationary and the UE has an active mmW connection. In some examples, the user may trigger the providing of the visual aid for adjusting the orientation of the UE.

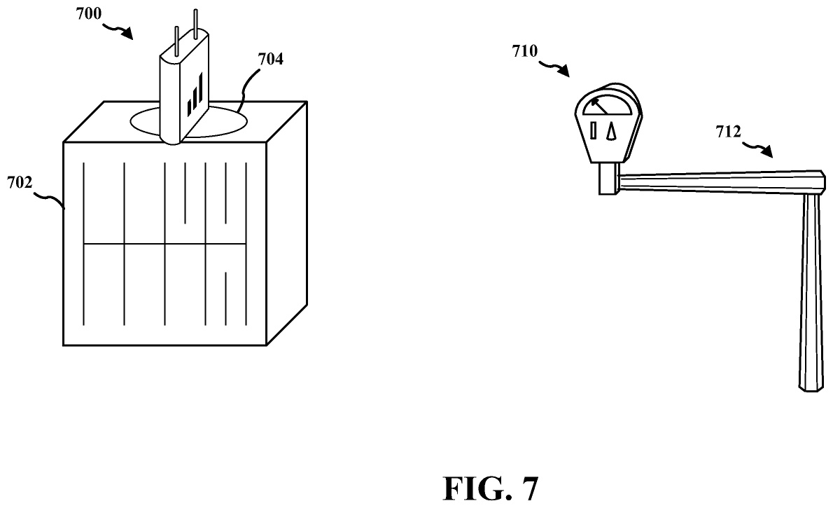

As another illustrative example, consider a UE that is mounted to a motorized holding apparatus. For example, FIG. 7 illustrates an example mobile hotspot 700 that is mounted to a motorized stand 702. The example motorized stand 702 includes a rotatable surface 704 that facilitates rotating the mobile hotspot 700 in a circular direction. FIG. 7 also illustrates an example smart meter 710 that is connected to a motorized holding apparatus 712. The example motorized holding apparatus 712 may facilitate moving the smart meter 710 in a horizontal direction and/or in a vertical direction.

The example UEs 700, 710 of FIG. 7 may determine an active mmW connection with a serving base station. In some examples, the UEs 700, 710 may include a tracking mode that, once enabled (e.g., by a user), facilitates the UE to automatically (e.g., without user input) estimate the direction of the serving base station beam relative to the spherical coverage mapping of the respective UE. In some such examples, the spherical coverage mapping may be a pre-characterized distribution of radiated power based on the beamforming codebook associated with the UE. In some examples, the UE may continuously perform the estimating of the direction of the serving base station beam. In some examples, the UE may periodically perform the estimating of the direction of the serving base station beam. In some examples, the UE may be triggered (e.g., by a user) to perform the estimating of the direction of the serving base station beam.

In some examples, after the UE 700, 710 estimates the direction of the serving base station beam, the UE may instruct the holding apparatus to apply rotations to change the orientation of the UE so that an improved connection may be established with the serving base station beam. For example, the mobile hotspot 700 may instruct the motorized stand 702 to cause the rotatable surface 704 to rotate so that the orientation of the mobile hotspot 700 in relation to the serving base station beam may result in an improved link quality of communication. With respect to the smart meter 710, the smart meter 710 may communicate with the motorized holding apparatus 712 to cause the motorized holding apparatus 712 to rotate the smart meter 710 so that the orientation of the smart meter 710 in relation to the serving base station beam may result in an improved link quality of communication. In this manner, the UEs 700, 710 may work with the holding apparatus 702, 712 to track the direction of the serving base station beam and to adjust the orientation of the UEs 700, 710 accordingly. It should be appreciated that the UEs 700, 710 may communicate with the respective holding apparatuses 702, 712 via wired and/or wireless communication systems, such as Wi-Fi connection, a Bluetooth® connection, etc.

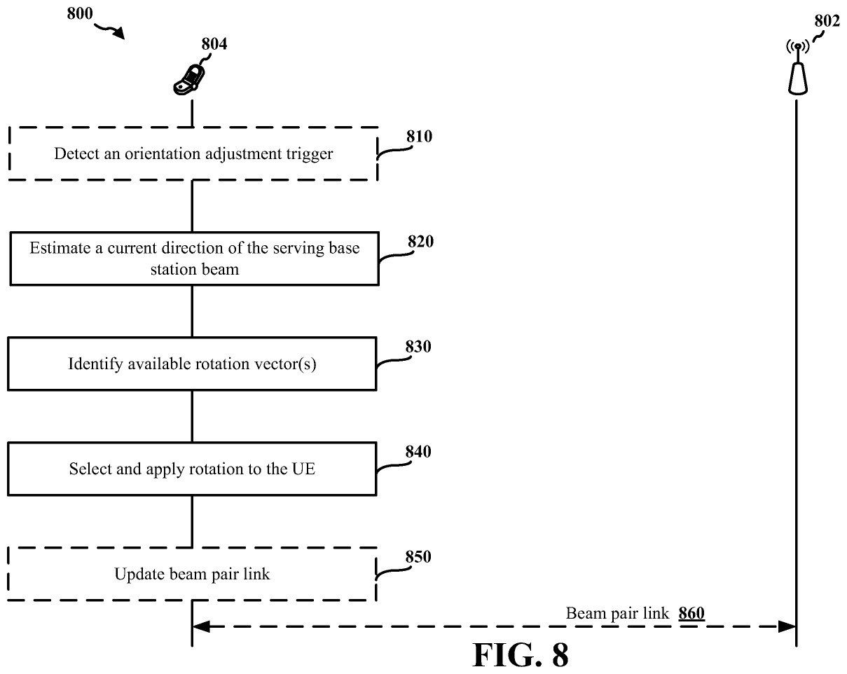

FIG. 8 illustrates an example of wireless communication 800 between a base station 802 and a UE 804, as presented herein. One or more aspects of the base station 802 may be implemented by the base station 102/180 of FIG. 1, the base station 310 of FIG. 3, and/or the base station 402 of FIG. 4. One or more aspects of the UE 804 may be implemented by the UE 104 of FIG. 1, the UE 350 of FIG. 3, the UE 404 of FIG. 4, the UE 600 of FIG. 6, and/or the UEs 700, 710 of FIG. 7.

It should be appreciated that while the wireless communication 800 includes one base station 802 in communication with one UE 804, in additional or alternative examples, the base station 802 may be in communication with any suitable quantity of UEs and/or other base stations, and/or the UE 804 may be in communication with any suitable quantity of base stations and/or other UEs. Thus, while certain of the transmissions between the base station 802 and the UE 804 are described as uplink transmissions and downlink transmissions, in other examples, any of the transmissions may additionally or alternatively be sidelink transmissions.

In the illustrated example, the base station 802 and the UE 804 are in communication (e.g., the base station 802 is a serving base station in relation to the UE 804). For example, the UE 804 may receive downlink transmissions from the base station 802 and/or may transmit uplink transmission to the base station 802. In the illustrated example, the base station 802 and the UE 804 are in mmW communication (e.g., communicating via mmW frequencies).

At 810, the UE 804 may detect an orientation adjustment trigger. In some examples, the orientation adjustment trigger may be associated with a link quality. For example, the UE 804 may detect a link quality of communication with the base station 802 that is less than a threshold value. In some examples, the adjustment orientation trigger may be a periodic event. For example, the UE 804 may periodically determine whether the current link quality of communication between the UE 804 and the base station 802 satisfies performance guidelines and/or if another orientation associated with a better link quality may be available. In some examples, the orientation adjustment trigger may be receiving user input to trigger the determining of whether the current link quality of communication between the UE 804 and the base station 802 satisfies performance guidelines and/or if another orientation associated with a better link quality may be available.

After detecting the orientation adjustment trigger, the UE 804 may then estimate, at 820, a current direction of the serving base station beam. In some examples, the UE 804 may estimate the current direction of the serving base station beam in relation to the spherical coverage mapping of the UE 804. For example, the UE 804 may have characterized its spherical coverage as radiated power (e.g., measured as EIRP, as EIS, etc.) in one or more spatial directions. In some examples, the spatial directions may be pre-selected spatial directions that may map to a “grid” over a sphere of coverage around the UE 804. In some such examples, estimating the current direction of the serving base station beam may correspond to mapping a direction to one of the spatial directions of the spherical coverage mapping.

In some examples, the UE 804 may use characteristics associated with a current UE serving beam to estimate the current direction of the serving base station beam. In some examples, the UE 804 may use measurements of the serving base station beam over a number of UE beams. In some examples, the UE 804 may use additional or alternative information available to the UE 804 to estimate the current direction of the serving base station beam. For example, the UE 804 may use location information of the UE 804 and the base station 802 to estimate the current direction of the serving base station beam. In some examples, the UE 804 may use orientation information of the UE 804 to estimate the current direction of the serving base station beam. For example, the UE 804 may use one or more sensors to determine its orientation relative to gravity and/or North to estimate the current direction of the serving base station beam. In some such examples, the orientation information may be available to the UE 804 via one or more sensors of the UE 804, via one or more sensors accessible to the UE 804, via a line-of-sight connection indication, etc. In some examples, the UE 804 may use historical information to estimate the current direction of the serving base station beam. For example, the UE 804 may determine that the current location of the UE 804 is the same as a previous location for which a direction of the serving base station beam was estimated and/or determined.

After the UE 804 estimates the current direction of the serving base station beam, the UE 804 may identify, at 830, available rotation vector(s). For example, the UE 804 may identify one or more rotation vector(s) to adjust (or re-align) the current orientation of the UE 804 based on the estimated direction of the serving base station beam. In some examples, the UE 804 may map the estimated direction of the current serving base station beam to the spherical coverage mapping to determine a rotation vector for adjusting the current orientation of the UE 804. For example, the UE 804 may determine a current orientation of the UE 804 in relation to the spherical coverage mapping and then identify a rotation vector so that the orientation of the UE 804 is aligned with the estimated current direction of the serving base station beam. It should be appreciated that the rotation vector may include moving the UE 804 in a horizontal direction, a vertical direction, and/or a three-dimensional direction.

In some examples, the UE 804 may also determine an estimated radiated power associated with re-aligning the orientation of the UE 804 based on the estimated current direction of the serving base station beam. In some such examples, the UE 804 may determine whether the estimated radiated power is greater than a current radiated power of the UE 804 associated with the current orientation of the UE. In some examples, the UE 804 may discard any rotation vectors that may result in estimated radiated powers that are less than or equal to the current radiated power of the UE 804.

At 840, the UE 804 may then select and apply a rotation to the UE 804. In some examples, the selecting and the applying of the rotation to the UE 804 may be performed manually. For example, the UE 804 may provide a visual aid (e.g., the example visual aid 620 of FIG. 6) to facilitate a user to adjust the orientation of the UE 804. For example, the UE 804 may cause a display device to display a three-dimensional spherical coverage model centered with respect to the estimated direction of the serving base station beam. In some such examples, the UE 804 may use sensor information (e.g., real-time sensor information) to provide visual feedback to the user as the user rotates the UE 804. For example, the UE 804 may use information obtained from a gyroscope, an accelerometer, a magnetometer, etc. to provide the visual feedback to the user. It should be appreciated that in some examples, the UE 804 may utilize additional or alternative interfaces for aiding the user in rotating the UE 804. For example, the UE 804 may provide audio feedback, may provide haptic feedback, etc. to facilitate the user in rotating the UE 804.

In some examples, the UE 804 may also include maximum permissible exposure (MPE) constraints in the visual aid. For example, if an antenna of the UE 804 is being covered by a finger, the UE 804 may attempt to align the spherical coverage of the UE with another portion to avoid beam directions that are covered by the finger.

In some examples, the selecting and the applying of the rotation to the UE 804 may be performed automatically (e.g., without user input). For example, the UE 804 may be mounted to a motorized holding apparatus (e.g., the example UEs 700, 710 of FIG. 7). In some such examples, the UE 804 may communicate with the motorized holding apparatus to cause the motorized holding apparatus to rotate the UE 804. The UE 804 may communicate with the motorized holding apparatus via wireless and/or wireless communication systems. In some examples, the UE 804 may provide the motorized holding apparatus with adjustments on how to rotate (e.g., adjust ten degrees in the horizontal direction and then five degrees in the vertical direction, etc.). In some examples, the UE 804 may provide the motorized holding apparatus with a desired spatial position and/or orientation and allow the motorized holding apparatus to determine the preferred adjustments. In some examples, the motorized holding apparatus may provide feedback to the UE 804 in terms of achievable range of motion, confirmation of adjustments, etc.

At 850, the UE 804 may update a beam pair link. For example, after orientation of the UE 804 is adjusted, the UE 804 may perform beam management techniques based on the updated orientation. In some such examples, the UE 804 may perform measurements to update the serving (or transmitting) beam of the UE and the beam pair link 860 with the base station 802. It should be appreciated that since the UE 804 is aware of the current direction of the serving base station pair, the performing of the beam management techniques may be improved (e.g., may be performed faster). For example, the UE 804 may prioritize measuring any beams in the direction of the current direction when performing the beam management techniques.

It should be appreciated that in some examples, the UE 804 may be unable to estimate, at 820, a current direction of the serving base station beam. For example, the link quality associated with the current orientation of the UE 804 may be such that the UE 804 is unable to detect a serving base station beam. In some such examples, the UE 804 may select (e.g., randomly select, select from a table, etc.) a spatial direction. The UE 804 may then rotate to align with the selected spatial direction and measure the link quality. In some such examples, the UE 804 may continue to select spatial directions until a serving base station beam is detected and/or the link quality improves so that a current direction of the serving base station may be estimated.

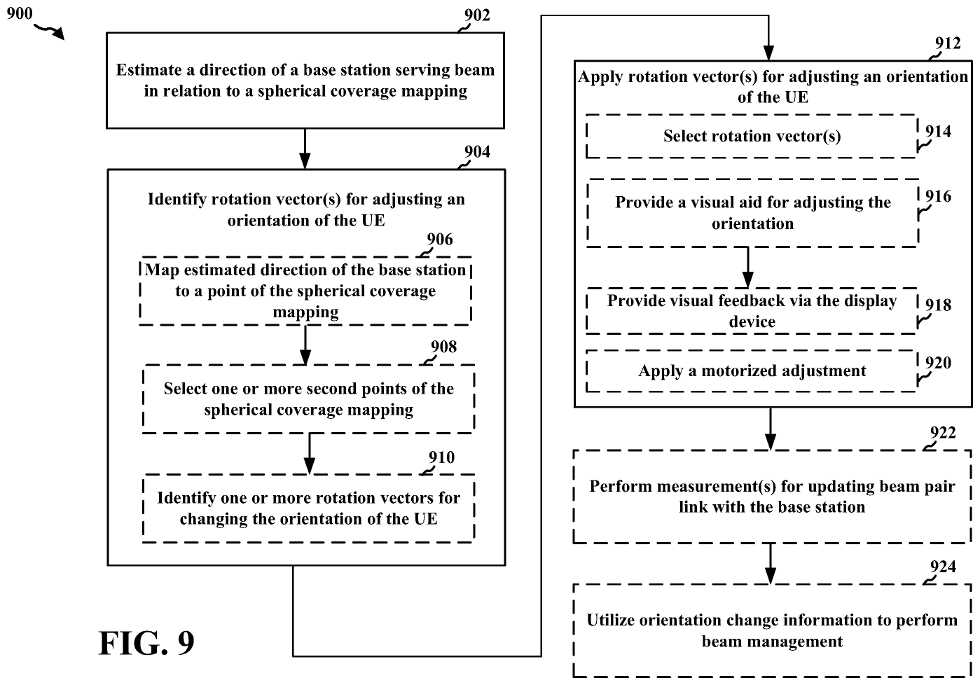

FIG. 9 is a flowchart 900 of a method of wireless communication. The method may be performed by a UE or a component of a UE (e.g., the UE 104, 350; the apparatus 1002/1002′; the processing system 1114, which may include the memory 360 and which may be the entire UE 350 or a component of the UE 350, such as the TX processor 368, the RX processor 356, and/or the controller/processor 359). Optional aspects are illustrated with a dashed line. The method may help for a UE to achieve an adjusted orientation relative to a base station in order to improve communication between the UE and the base station.

At 902, the UE estimates a direction of a base station serving beam in relation to a spherical coverage mapping of the UE. The estimation may be performed, e.g., by direction component 1008 of apparatus 1002. The spherical coverage mapping may provide a distribution of coverage of the UE in a three-dimensional space. The spherical coverage mapping may be characterized in terms of EIRP or EIS. The estimation of the direction of the base station serving beam may be performed based on a current UE serving beam, measurement(s) of a base station serving beam over a number of UE beams, location information of the base station and the UE, orientation information of the UE, and/or a history of directions of the base station serving beam. Example aspects of estimation of the direction of the base station serving beam are described in connection with 820 in FIG. 8.

At 904, the UE identifies one or more rotation vectors for adjusting an orientation of the UE based on the direction of the base station serving beam and the spherical coverage mapping. The rotation vector(s) may be identified, e.g., by rotation vector component 1010 of apparatus 1002. Example aspects of identifying rotation vector(s) for adjusting the orientation of the UE are described in connection with 830 in FIG. 8. As part of identifying the rotation vector(s), at 904, the UE may map the estimated direction of the base station serving beam to a first point of the spherical coverage mapping, at 906. The estimated direction may be mapped, e.g., by map component 1012 of apparatus 1002. Then, at 908, the UE may select one or more second points of the special coverage mapping. The one or more second points may be selected, e.g., by point selection component 1014 of apparatus 1002. In some examples, coverage at each of the selected one or more second points may be relatively better than coverage at the first point. At 910, the UE may identify one or more rotation vectors for changing the orientation of the UE so that each of the one or more rotation vectors is to align the base station serving beam with respective ones of the one or more second points in the spherical coverage mapping. The rotation vector(s) may be identified, e.g., by rotation vector component 1010 of apparatus 1002.

At 912, the UE applies at least one rotation vector to adjust the orientation of the UE. The rotation vector(s) may be applied e.g., by application component 1016 of apparatus 1002. Example aspects of applying the rotation vector(s) are described in connection with 840 in FIG. 8. The UE may apply the rotation vector(s) in any of a number of ways. As a part of applying the rotation vector(s), the UE may select rotation vector(s) for adjusting the orientation of the UE, as illustrated at 914. For example, the selection component 1018 of apparatus 1002 may perform the selection.

The selection of the rotation vector(s), at 914, may be via user interaction. For example, the UE may provide a visual aid via a display device for adjusting the orientation of the UE based on the rotation vector(s), at 916. At 918, the UE may provide visual feedback via the display device as the UE is rotated. For example, the visual aid and/or visual feedback may be displayed, e.g., by visual aid component 1020 and/or display component 1024. The visual aid that is provided at 916 may be triggered based on one or more conditions associated with the UE. As an example, the visual aid may be initiated in response to a user input.

The selection of the rotation vector(s), at 914, may be performed automatically.

The UE may be mounted to, coupled to, or received in a motorized apparatus. The rotation vector(s) may be applied by sending information to the motorized apparatus for adjusting the orientation of the UE. For example, the rotation vectors may be applied by motorized adjustment component 1002 and/or motor component 1026 of apparatus 1002. The UE may communicate with the motorized apparatus via a wired connection or a wireless connection.

As illustrated at 922, the UE may perform measurement(s) for updating a beam pair link with the base station after the applying of the selected at least one rotation vector. The measurement may be performed, e.g., by measurement component 1030 of apparatus 1002. Example aspects of performing measurements for updating a beam pair are described in connection with 850 in FIG. 8.

As illustrated at 924, the UE may utilize orientation change information to perform beam management. For example, the beam management may be performed by beam management component 1028 of apparatus 1002. Example aspects of beam management are described in connection with 850 in FIG. 8.

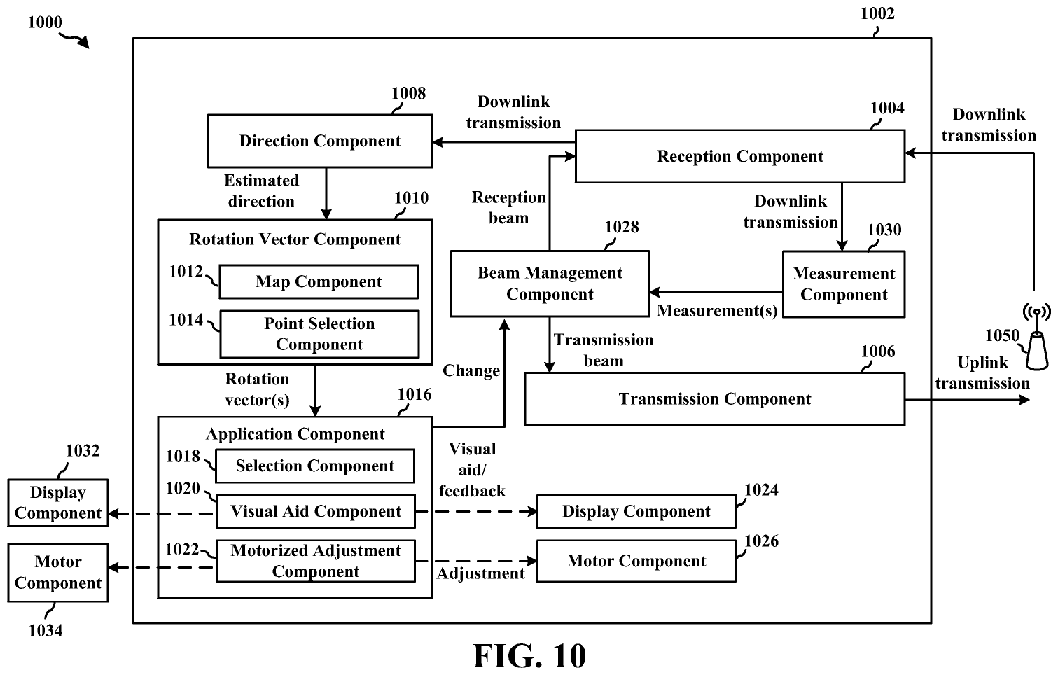

FIG. 10 is a conceptual data flow diagram 1000 illustrating the data flow between different means/components in an example apparatus 1002. The apparatus may be a UE or a component of a UE. The apparatus may include a reception component 1004 configured to receive downlink communication from a base station 1050. The apparatus may include a transmission component 1006 configured to transmit uplink communication to the base station 1050. The apparatus may include a direction component 1008 configured to estimate a direction of a base station serving beam in relation to a spherical coverage mapping of the UE. The apparatus may include a rotation vector component 1010 configured to identify one or more rotation vectors for adjusting an orientation of the UE based on the direction of the base station serving beam and the spherical coverage mapping. The rotation vector component 1010 may include a map component 1012 configured to map the estimated direction of the base station serving beam to a first point of the spherical coverage mapping and/or a point selection component 1014 configured to select one or more second points of the spherical coverage mapping. The rotation vector component 1010 may identify one or more rotation vectors for changing the orientation of the UE, each one of the one or more rotation vectors to align the base station serving beam with respective ones of the second points in the spherical coverage mapping. The apparatus may include an application component 1016 configured to apply at least one rotation vector to adjust the orientation of the UE. The application component 1016 may include a selection component 1018 configured to select at least one of the rotation vectors for adjusting the orientation of the UE. The application component 1016 may include a visual aid component 1020 configured to provide a visual aid to a display device for adjusting the orientation of the UE based on the rotation vector and visual feedback as the UE is rotated. As illustrated in FIG. 10, the display device may correspond to a display component 1024 that is comprised in apparatus 1002 or may comprise a display component 1032 that is external to apparatus 1002. The apparatus may include a motorized adjustment component 1022 configured to apply the rotation vector(s) by sending instructions to a motorized apparatus that changes the orientation of the UE to better align with the base station's serving beam(s). The motorized adjustment component 1002 may send information for changing the orientation of the UE to a motor component 1026 that is comprised in the apparatus 1002 and/or may send the information to a motor component 1034 that is separate from the apparatus 1002. For example, the motor component 1034 may communicate with the apparatus 1002 with the apparatus 1002 via a wired connection or a wireless connection. The apparatus may include a measurement component 1030 configured to perform one or more measurements for updating a beam pair link with the base station after the applying of the selected at least one rotation vector. The apparatus may include a beam management component 1028 configured to utilize orientation change information to perform beam management.

The apparatus may include additional components that perform each of the blocks of the algorithm in the aforementioned flowchart of FIG. 9. As such, each block in the aforementioned flowchart of FIG. 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

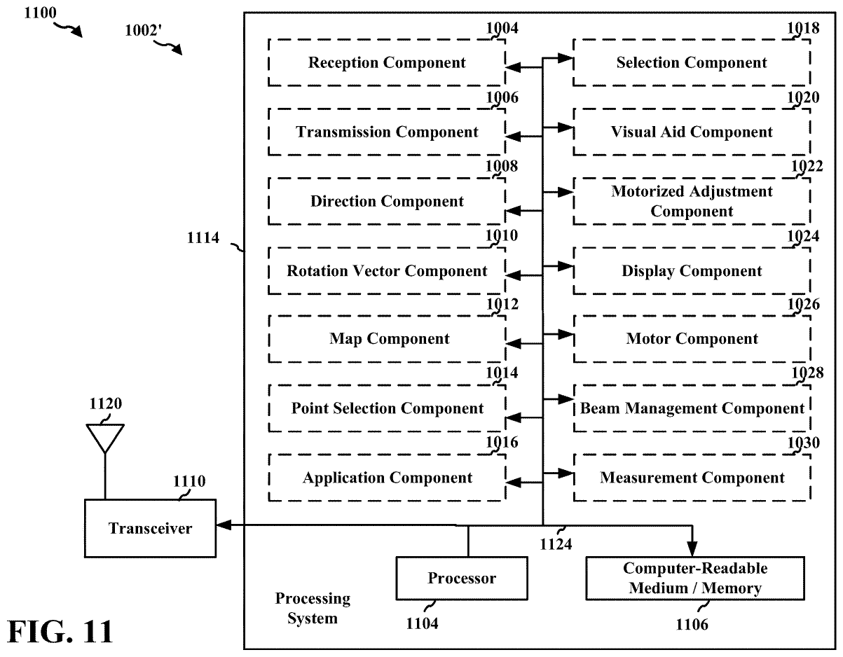

FIG. 11 is a diagram 1100 illustrating an example of a hardware implementation for an apparatus 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware components, represented by the processor 1104, the components 1004, 1006, 1008, 1010, 1012, 1014, 1016, 1018, 1020, 1024, 1026, 1028, 1030, and the computer-readable medium/memory 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The transceiver 1110 receives a signal from the one or more antennas 1120, extracts information from the received signal, and provides the extracted information to the processing system 1114, specifically the reception component 1004. In addition, the transceiver 1110 receives information from the processing system 1114, specifically the transmission component 1006, and based on the received information, generates a signal to be applied to the one or more antennas 1120. The processing system 1114 includes a processor 1104 coupled to a computer-readable medium/memory 1106. The processor 1104 is responsible for general processing, including the execution of software stored on the computer-readable medium/memory 1106. The software, when executed by the processor 1104, causes the processing system 1114 to perform the various functions described supra for any particular apparatus. The computer-readable medium/memory 1106 may also be used for storing data that is manipulated by the processor 1104 when executing software. The processing system 1114 further includes at least one of the components 1004, 1006, 1008, 1010, 1012, 1014, 1016, 1018, 1020, 1024, 1026, 1028, 1030. The components may be software components running in the processor 1104, resident/stored in the computer readable medium/memory 1106, one or more hardware components coupled to the processor 1104, or some combination thereof. The processing system 1114 may be a component of the UE 350 and may include the memory 360 and/or at least one of the TX processor 368, the RX processor 356, and the controller/processor 359. Alternatively, the processing system 1114 may be the entire UE (e.g., see 350 of FIG. 3).

In one configuration, the apparatus 1002/1002′ for wireless communication includes means for estimating a direction of a base station serving beam in relation to a spherical coverage mapping of the UE. The apparatus may include means for identifying one or more rotation vectors for adjusting an orientation of the UE based on the direction of the base station serving beam and the spherical coverage mapping. The apparatus may include means for applying at least one rotation vector to adjust the orientation of the UE. The apparatus may include means for performing one or more measurements for updating a beam pair link with the base station after the applying of the selected at least one rotation vector. The apparatus may include means for mapping the estimated direction of the base station serving beam to a first point of the spherical coverage mapping. The apparatus may include means for selecting one or more second points of the spherical coverage mapping, and where coverage at the one or more seconds points is relatively better than coverage at the first point. The apparatus may include means for identifying one or more rotation vectors for changing the orientation of the UE such that the base station serving beam is aligned with the respective ones of the second points in the spherical coverage mapping. The apparatus may include means for selecting at least one of the rotation vectors for adjusting the alignment of the UE. The apparatus may include means for providing a visual aid via a display device for adjusting the alignment of the UE based on the rotation vector. The apparatus may include means for providing visual feedback via the display device as the UE is rotated. The apparatus may include means for adjusting the alignment of the UE using a motorized apparatus. The apparatus may include means for communicating with the motorized apparatus via a wired connection or a wireless connection. The apparatus may include means for utilizing orientation change information to perform beam management. The aforementioned means may be one or more of the aforementioned components of the apparatus 1002 and/or the processing system 1114 of the apparatus 1002′ configured to perform the functions recited by the aforementioned means. As described supra, the processing system 1114 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The following examples are illustrative only and may be combined with aspects of other embodiments or teachings described herein, without limitation.

Example 1 is a method of wireless communication at a user equipment (UE), comprising: estimating a direction of a base station serving beam in relation to a spherical coverage mapping of the UE; identifying one or more rotation vectors for adjusting an orientation of the UE based on the direction of the base station serving beam and the spherical coverage mapping; and applying at least one rotation vector to adjust the orientation of the UE.

In Example 2, the method of Example 1 further includes performing one or more measurements for updating a beam pair link with a base station after the applying of the selected at least one rotation vector.

In Example 3, the method of any of Example 1 or Example 2 further includes that the spherical coverage mapping provides a distribution of coverage of the UE in a three-dimensional space.

In Example 4, the method of any of Example 1 to Example 3 further includes that the spherical coverage mapping is characterized in terms of at least one of effective isotropic radiated power (EIRP) and effective isotropic sensitivity (EIS).

In Example 5, the method of any of Example 1 to Example 4 further includes that the estimating of the direction of the base station serving beam is performed based on one or more of a current UE serving beam, one or more measurements of the base station serving beam over a number of UE beams, location information of a base station and the UE, orientation information of the UE, and a history of directions of the base station serving beam.

In Example 6, the method of any of Example 1 to Example 5 further includes that the identifying the one or more rotation vectors includes: mapping the estimated direction of a base station serving beam to a first point of the spherical coverage mapping; selecting one or more second points of the spherical coverage mapping, wherein coverage at the one or more second points is relatively better than coverage at the first point; and identifying one or more rotation vectors for changing the orientation of the UE, each of the one or more rotation vectors to align the base station serving beam with respective ones of the second points in the spherical coverage mapping.

In Equation 7, the method of any of Example 1 to Example 6 further includes that the applying of the at least one rotation vector includes selecting at least one of the rotation vectors for adjusting the orientation of the UE.

In Equation 8, the method of any of Example 1 to Example 7 further includes that the selecting of the at least one rotation vector is performed based on received user input.

In Equation 9, the method of any of Example 1 to Example 8 further includes providing a visual aid to a display device for adjusting the orientation of the UE based on the rotation vector.

In Equation 10, the method of any of Example 1 to Example 9 further includes providing visual feedback to the display device as the UE is rotated.

In Equation 11, the method of any of Example 1 to Example 10 further includes that the visual aid is triggered based on one or more conditions associated with the UE.

In Equation 12, the method of any of Example 1 to Example 11 further includes that the visual aid is initiated in response to a user input.

In Equation 13, the method of any of Example 1 to Example 12 further includes that the selecting of the at least one rotation vector is performed automatically.

In Equation 14, the method of any of Example 1 to Example 13 further includes that the applying of the at least one rotation vector includes sending information to a motorized apparatus for adjusting the orientation of the UE.

In Equation 15, the method of any of Example 1 to Example 14 further includes that the UE communicates with the motorized apparatus via a wired connection or a wireless connection.

In Equation 16, the method of any of Example 1 to Example 15 further includes utilizing orientation change information to perform beam management.

Example 17 is a system or apparatus including means for implementing a method or realizing an apparatus as in any of Examples 1 to 16.

Example 18 is a device including one or more processors and one or more memories in electronic communication with the one or more processors storing instructions executable by the one or more processors to cause a system or an apparatus to implement a method as in any of Examples 1 to 16.

Example 19 is a non-transitory computer-readable medium storing instructions executable by one or more processors to cause the one or more processors to implement a method as in any of Examples 1 to 16.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication at a user equipment (UE), comprising:
estimating a direction of a base station serving beam in relation to a spherical coverage mapping of the UE;
identifying one or more rotation vectors for adjusting an orientation of the UE based on the direction of the base station serving beam and the spherical coverage mapping; and
applying at least one rotation vector to adjust the orientation of the UE.

2. The method of claim 1, further comprising:
performing one or more measurements for updating a beam pair link with a base station after the applying of the selected at least one rotation vector.

3. The method of claim 1, wherein the spherical coverage mapping provides a distribution of coverage of the UE in a three-dimensional space.

4. The method of claim 3, wherein the spherical coverage mapping is characterized in terms of at least one of effective isotropic radiated power (EIRP) and effective isotropic sensitivity (EIS).

5. The method of claim 1, wherein the estimating of the direction of the base station serving beam is performed based on one or more of a current UE serving beam, one or more measurements of the base station serving beam over a number of UE beams, location information of a base station and the UE, orientation information of the UE, and a history of directions of the base station serving beam.

6. The method of claim 1, wherein the identifying the one or more rotation vectors includes:
mapping the estimated direction of a base station serving beam to a first point of the spherical coverage mapping;
selecting one or more second points of the spherical coverage mapping, wherein coverage at the one or more second points is relatively better than coverage at the first point; and
identifying one or more rotation vectors for changing the orientation of the UE, each of the one or more rotation vectors to align the base station serving beam with respective ones of the second points in the spherical coverage mapping.

7. The method of claim 1, wherein the applying of the at least one rotation vector includes selecting at least one of the rotation vectors for adjusting the orientation of the UE.

8. The method of claim 7, wherein the selecting of the at least one rotation vector is performed based on received user input.

9. The method of claim 8, further comprising providing a visual aid to a display device for adjusting the orientation of the UE based on the rotation vector.

10. The method of claim 9, further comprising providing visual feedback to the display device as the UE is rotated.

11. The method of claim 9, wherein the visual aid is triggered based on one or more conditions associated with the UE.

12. The method of claim 9, wherein the visual aid is initiated in response to a user input.

13. The method of claim 7, wherein the selecting of the at least one rotation vector is performed automatically.

14. The method of claim 13, wherein the applying of the at least one rotation vector includes sending information to a motorized apparatus for adjusting the orientation of the UE.

15. The method of claim 14, wherein the UE communicates with the motorized apparatus via a wired connection or a wireless connection.

16. The method of claim 1, further comprising:
utilizing orientation change information to perform beam management.

17. An apparatus for wireless communication at a user equipment (UE), comprising:
means for estimating a direction of a base station serving beam in relation to a spherical coverage mapping of the UE;
means for identifying one or more rotation vectors for adjusting an orientation of the UE based on the direction of the base station serving beam and the spherical coverage mapping; and
means for applying at least one rotation vector to adjust the orientation of the UE.

18. The apparatus of claim 17, further comprising:
means for performing one or more measurements for updating a beam pair link with a base station after the applying of the selected at least one rotation vector.

19. The apparatus of claim 17, wherein the identifying the one or more rotation vectors includes:
means for mapping the estimated direction of a base station serving beam to a first point of the spherical coverage mapping;
means for selecting one or more second points of the spherical coverage mapping, wherein coverage at the one or more second points is relatively better than coverage at the first point; and
means for identifying one or more rotation vectors for changing the orientation of the UE, each of the one or more rotation vectors to align the base station serving beam with respective ones of the second points in the spherical coverage mapping.

20. The apparatus of claim 17, wherein the means for applying the at least one rotation vector is configured to select at least one of the rotation vectors for adjusting the orientation of the UE.

21. The apparatus of claim 20, wherein the selecting of the at least one rotation vector is performed based on received user input.

22. The apparatus of claim 21, further comprising means for providing a visual aid to a display device for adjusting the orientation of the UE based on the rotation vector.

23. The apparatus of claim 22, further comprising means for providing visual feedback to the display device as the UE is rotated.

24. The apparatus of claim 20, wherein the means for selecting the at least one rotation vector is performed automatically.

25. The apparatus of claim 24, wherein the means for applying the at least one rotation vector is configured to send information to a motorized apparatus for adjusting the orientation of the UE.

26. The apparatus of claim 17, further comprising:
means for utilizing orientation change information to perform beam management.

27. An apparatus for wireless communication at a base station, comprising:
a memory; and
at least one processor coupled to the memory and configured to:
estimate a direction of a base station serving beam in relation to a spherical coverage mapping of the UE;
identify one or more rotation vectors for adjusting an orientation of the UE based on the direction of the base station serving beam and the spherical coverage mapping; and
apply at least one rotation vector to adjust the orientation of the UE.

28. The apparatus of claim 27, wherein the at least one processor is further configured to:
perform one or more measurements for updating a beam pair link with a base station after the applying of the selected at least one rotation vector.

29. The apparatus of claim 27, wherein the at least one processor is further configured to identify the one or more rotation vectors by:
mapping the estimated direction of a base station serving beam to a first point of the spherical coverage mapping;
selecting one or more second points of the spherical coverage mapping, wherein coverage at the one or more second points is relatively better than coverage at the first point; and
identifying one or more rotation vectors for changing the orientation of the UE, each of the one or more rotation vectors to align the base station serving beam with respective ones of the second points in the spherical coverage mapping.

30. A computer-readable medium storing computer executable code for wireless communication at a user equipment (UE), the code, when executed, cause a processor to:
estimate a direction of a base station serving beam in relation to a spherical coverage mapping of the UE;
identify one or more rotation vectors for adjusting an orientation of the UE based on the direction of the base station serving beam and the spherical coverage mapping; and
apply at least one rotation vector to adjust the orientation of the UE.
